(19) United States
(12) Patent Application Publication
(10) Pub. No.: US 2021/0357800 A1
(43) Pub. Date: Nov. 18, 2021

(54) DISTRIBUTED DECENTRALIZED MACHINE LEARNING MODEL TRAINING

(71) Applicant: Seagate Technology LLC, Fremont, CA (US)

(72) Inventors: Naman Sharma, Singapore (SG); Varun Reddy Boddu, Singapore (SG); Alphonsus John Kwok Kwong Heng, Singapore (SG); Hui Ning Tan, Singapore (SG)

(21) Appl. No.: 15/930,776

(22) Filed: May 13, 2020

(51) Int. Cl. G06N 20/00; H04L 29/08

(52) U.S. Cl. CPC G06N 20/00; H04L 67/104

(57) ABSTRACT

Systems and methods are disclosed for distributed decentralized machine learning model training. In certain embodiments, a first node in a network may comprise a circuit configured to receive an initial machine learning model having an initial parameter set, apply the local data to update parameters of the initial machine learning model to generate an updated machine learning model, transmit a copy of the updated machine learning model from the first node to a plurality of neighboring nodes in the network via a network interface, receive, via the network interface, a modified machine learning model from a first neighboring node, the modified machine learning model having parameters set based on local data of the first neighboring node, modify the updated machine learning model based on the modified machine learning model, and apply the updated machine learning model to control operations at the first node.

### SUMMARY

In certain embodiments, an method may comprise receiving, at a first node in a network, an initial machine learning model having an initial parameter set, applying local data of the first node to update parameters of the initial machine learning model to generate an updated machine learning model, transmitting a copy of the updated machine learning model from the first node to a first neighboring node in the network, receiving, at the first node, a modified machine learning model from the first neighboring node, the modified machine learning model having parameters set based on local data of the first neighboring node, modifying, at the first node, the updated machine learning model based on the modified machine learning model, and applying the updated machine learning model to perform operations at the first node.

In certain embodiments, a memory device may store instructions that, when executed, cause a processor to perform a method comprising: receiving, at a node in a network, the node including the processor, an initial machine learning model having an initial parameter set, applying local data of the first node to update parameters of the initial machine learning model to generate an updated machine learning model, transmitting a copy of the updated machine learning model from the first node to a first neighboring node in the network, receiving, at the first node, a modified machine learning model from the first neighboring node, the modified machine learning model having parameters set based on local data of the first neighboring node, modifying, at the first node, the updated machine learning model based on the modified machine learning model, and applying the updated machine learning model to perform operations at the first node.

In certain embodiments, an apparatus may comprise a first node in a network, the first node including a computing system having a network interface configured to connect the first node to the network, a nonvolatile memory configured to store local data, and a circuit. The circuit may be configured to execute a distributed machine learning model training process, including: receive an initial machine learning model having an initial parameter set, apply the local data to update parameters of the initial machine learning model to generate an updated machine learning model, transmit a copy of the updated machine learning model from the first node to a plurality of neighboring nodes in the network via the network interface, receive, via the network interface, a modified machine learning model from a first neighboring node, the modified machine learning model having parameters set based on local data of the first neighboring node, modify the updated machine learning model based on the modified machine learning model, and apply the updated machine learning model to control operations at the first node

### BRIEF DESCRIPTION OF THE DRAWINGS

FIG. 1 is a diagram of a system for distributed decentralized machine learning model training, in accordance with certain embodiments of the present disclosure;

FIG. 2 is a diagram of a system for distributed decentralized machine learning model training, in accordance with certain embodiments of the present disclosure;

FIG. 3 is a flowchart of a method for distributed decentralized machine learning model training, in accordance with certain embodiments of the present disclosure;

FIG. 4 is a diagram of a system for distributed decentralized machine learning model training, in accordance with certain embodiments of the present disclosure; and

FIG. 5 is a diagram of a system for distributed decentralized machine learning model training, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of one or more computing devices (e.g., logic, circuits, processors, etc.) configured to perform a particular task or job, or may include instructions that, when executed, can cause one or more processors to perform a particular task or job, or any combination thereof. Further, the methods described herein may be implemented as a computer readable storage medium or memory device including instructions that, when executed, cause one or more processors to perform the methods.

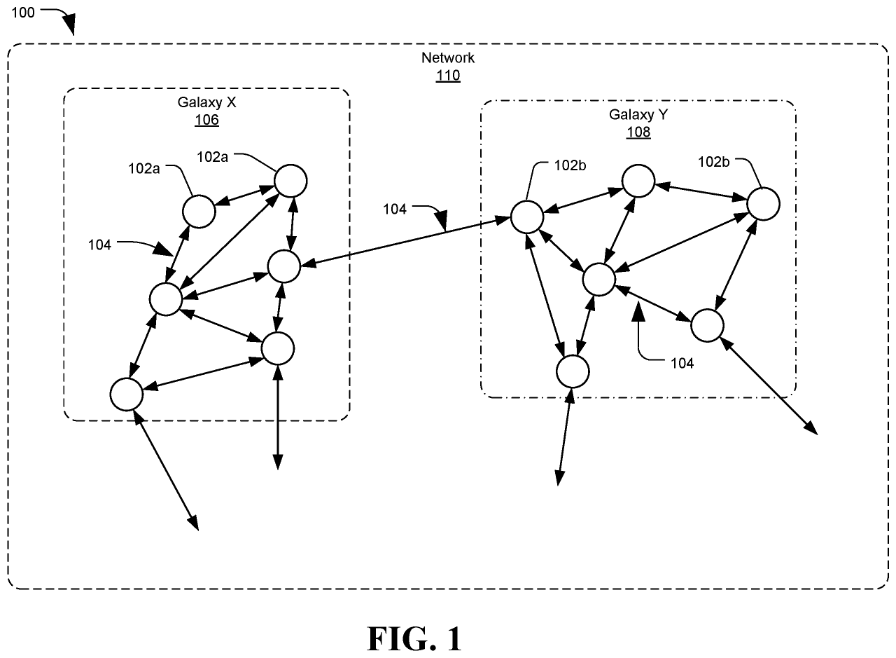

FIG. 1 is a diagram of a system, generally designated 100, for distributed decentralized machine learning model training, in accordance with certain embodiments of the present disclosure. Machine learning, or computer learning, can refer to a branch of artificial intelligence, in which computer systems can perform data analysis to identify patterns, make decisions, and perform tasks based on the data without explicit instructions or human intervention. Machine learning algorithms may be applied to build a mathematical model using sample data, which may also be called “training data”, in a process referred to as training the model. The model, having been generated or updated based on the training data, can be used by a computer system to make predictions or decisions for performing a task, without explicit programming for performing the task. Machine learning can be applied to a variety of tasks and applications, including marketing, fraud detection or email filtering, health diagnostics, computer vision, or other applications where it may be difficult to write a conventional computer program for performing the task. Machine learning and model training may be an iterative process, where the model may be updated as more data is received.

More data can make for more accurate or effective models. One approach to machine learning may be to aggregate large amounts of data, possibly from various distributed sources, at a central computer system which may process the data to update its own data model. However, these various distributed data sources may not want to expose their private or proprietary data to an outside aggregator. The data may include sensitive or private information from individuals, such as financial or medical records, or valuable company records such as customer lists, which a data source may not wish to share. Scrubbing the data of personally identifying or sensitive information may be time-intensive and wasteful, and sensitive information may still slip through along with the non-sensitive data. Scrubbing the data may also remove potentially useful information that would improve model accuracy. Further, a centralized system may require vast computational resources to store and process the data.

Another approach to machine learning may include using federated learning, in which a central processing authority distributes a machine learning model to various edge devices or nodes in a network. Those nodes may update the model based on local data at the node, offloading some of the processing and data storage burden away from the central processing authority. The central authority then collects the updated models from the nodes and consolidates those models together to produce a single global model. This process may protect private data, based on implementation, but is still controlled by a central server that distributes and then combines and controls the model information from all of the nodes.

An improved system is described herein, in which a distributed, decentralized process may be applied for machine learning model training. A distributed, decentralized model training approach may provide differential privacy of data while distributing workloads and data storage, and also avoid a centralized authority controlling or owning the model. With some implementations, locality-specific versions of the model may be generated, providing improved results for each locality.

The model training can be performed via a network 110, such as a peer-to-peer network of distributed nodes 102a, 102b. The network 110 may be made up of a plurality of nodes 102a, 102b and edges 104.

The nodes 102a, 102b may comprise computing systems or groups using the machine learning model described herein, and may sometimes be described as “users”. Users may refer to the computing systems, or to a human user of the computing system, whose personal interests and data may influence the machine learning model. A node 102a, 102b may include individual or personal computing devices such as laptops, desktops, or smart phones; backend systems such as one or more server computing systems; sub-networks, such as a university, medical campus, or business intranet; other computing system arrangements; or any combination thereof. Each node 102a, 102b may store local data which may be used to update or adapt a machine learning model.

The edges 104 may represent physical connections between nodes 102a, 102b, or may represent one or more other connections between the nodes, such as a similarity value representing how alike various nodes are in a particular aspect. For example, the similarity value may represent a geographic proximity between two nodes. In another example, the similarity value may indicate how alike two types of nodes are, where nodes representing medical institutions may have a high similarity with each other, but less similarity with individual user nodes or business or corporate nodes. The edges 104 may be weighted. The weights may represent a strength or importance of the connections between a pair of nodes. For example, for physical connections between nodes, a higher edge 104 weight may indicate a fast or high-capacity data connection. For similarity values, a high edge 104 weight may include very similar types of nodes 102a, 102b, while a low edge weight may indicate that two nodes are dissimilar. In the case of edges 104 representing similarity values between nodes 102a, 102b, edges may only be represented or considered between nodes having a similarity value over a selected threshold, so that very dissimilar nodes may not appear to have a connection in the network.

Based on the edges 104 or connections between nodes 102a, 102b, the network 110 may be considered an amalgamation of localized groups of nodes, referred to herein as a galaxy. In the depicted example of network 110, the nodes 102a, 102b are divided into Galaxy X 106, and Galaxy Y 108. The galaxies may encompass nodes sharing one or more particular attributes or having high similarity in one or more categories. Which nodes 102a, 102b are categorized into the various galaxies, and the existence of edges 104 between particular nodes of different galaxies, may depend on the connections and values of the edges 104 between nodes. For an example in which galaxies are based on geographical location, the nodes 102a in Galaxy X 106 may all be located in New York, while the nodes 102b in Galaxy Y 108 may all be located in Pennsylvania. Edges 104 between galaxies may exist between nodes close to a geographical boundary. In another example in which galaxies are based on the similarity of one or more attributes, the nodes 102a in Galaxy X 106 may be hospitals, while the nodes 102b in Galaxy Y 108 may be manufacturers. Nodes sharing high similarity values on one or more attributes may be grouped together into a galaxy, while a similarity value that is not high enough to group nodes together may still be represented as an edge 104 between nodes in different galaxies. For example, a node 102b of a manufacturer of medical supplies may share an edge 104 with a hospital node 102a in a different galaxy (e.g. Galaxy X 106). In some examples, galaxies may overlap, with certain nodes included in multiple galaxies.

Galaxies may be defined based on graph clustering or group detection algorithms. Galaxies may be defined based on the presence or absence of connections between nodes, and the weights of those connections, and accordingly the algorithms may use values from the similarity matrix. The number of galaxies in a machine learning network, or which nodes are grouped into which galaxies, may not directly influence the decentralized machine learning model training system described herein, but may reveal how many sub-models evolve from a base machine learning model. Different galaxies may produce different evolutions of a base model. Each node within a galaxy may arrive at a sub-model better suited to an area of interest of that particular galaxy than a single unified model trained across all nodes in the network.

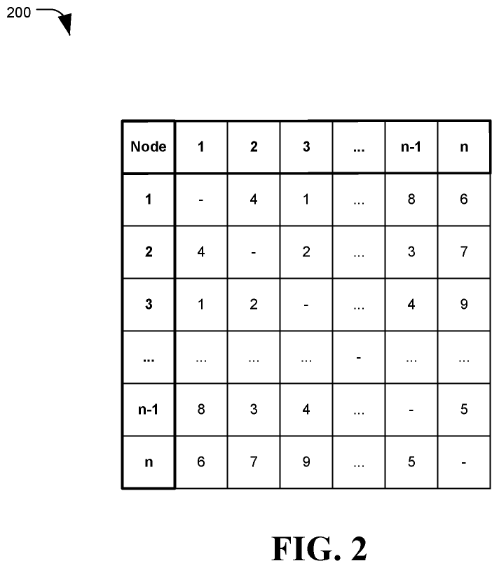

Another parameter of the network 110 may take the form of a similarity matrix. The similarity matrix may define how similar or close pairs of nodes 102a, 102b in the network 110 are. The similarity matrix may include a data structure or database having numeric representations of the similarity between nodes 102a, 102b, even if those nodes are not shown having connecting edges 104 on the network 110 diagram. An example similarity matrix is depicted in FIG. 2.

FIG. 2 is a diagram of a system, generally designated 200, for distributed decentralized machine learning model training, in accordance with certain embodiments of the present disclosure. In particular, system 200 includes a node similarity matrix, which may store information representing how similar or close pairs of nodes are in a network. The matrix 200 may be an (n×n) matrix, where “n” may represent the number of nodes in the network. The nodes in the network, as discussed herein, may be limited to those nodes participating in the distributed decentralized machine learning model training system. Therefore if all the nodes are connected via the internet, the “n” nodes may include only those computing systems connected to the internet that are updating and distributing the machine learning model of the present disclosure, and may not include all the other non-participating computing systems on the internet. A copy of the similarity matrix 200 may be stored to each of the “n” nodes.

The node similarity matrix 200 may be used to define the different galaxies and the relative weights on the edges connecting different nodes. There may be various methods of constructing the node similarity matrix 200. How the node similarity matrix 200 is constructed, and how the values for the matrix are calculated, can be based on a specific use case. For example, if looking at geographical nodes, users closer to each other in terms of geographical distance would have a higher similarity. Taking another example of machine learning models for recommendation engines, users with similar tastes in goods or entertainment may have higher node similarity. In an example, the similarity matrix can be computed securely using multi-party compute (MPC). Each user or node can have a vector which describes itself. Using MPC, a similarity matrix can be constructed between all parties without sharing these vectors themselves. There may be no need to leak private data, since knowing the similarity matrix does not reveal anything about the individual vectors of each user.

In the depicted example, the similarity between each node may be represented as an integer value, although other similarity metrics may also be used, such as letters, combinations of numbers, equations, or other metrics. In some embodiments, multiple similarity values between each node may be tracked, for example with a different similarity value for attributes such as geographical region, age, income, etc., or multiple attribute similarity scores may be aggregated into a single value.

In some embodiments, the similarity values in the similarity matrix may determine the existence, values, or weights of edges between nodes, as well as which nodes comprise which galaxies. For example, a high similarity between nodes may indicate an edge between those nodes. The similarity matrix values may be used in graph clustering or grouping algorithms to determine galaxies. In some embodiments, with the similarity matrix 200 tracking different scores for different attributes, which “galaxy” a node is included in may change. For example, node 1 may be grouped with node 5 based on geography, but may be grouped with node 8 based on interests in a particular category of goods. Other embodiments are also possible. A high similarity value between a pair of nodes in the matrix 200 may also indicate a high weight on an edge between the nodes. The weight of an edge may influence how a node updates its local machine learning model based on feedback from its neighboring nodes. Model updates or information from neighbors with high similarity values may be given more influence when a node updates its own model than updates received from neighbors with low similarity values.

When a node joins the network, it may obtain a copy of the similarity matrix 200, either along with the machine learning model, or received from neighboring nodes. All nodes within the network may have a same, updated copy of the similarity matrix 200, which may be shared via various peer-to-peer or distributed data update methods. The matrix 200 may only need to be updated when a vector of a node changes, which can result in changes to the matrix 200. Changes to a user or node vector may be uncommon, but when it happens the node may update its own copy of the similarity matrix 200 and distribute it to the network so that other nodes may update their local copy. In some examples, similarity matrix updates may be distributed at selected time intervals or update events. A node with a changed vector may continue to use the shared copy of the matrix 200 until an updated version can be shared to the network, so that all nodes are always using a same version of the matrix 200.

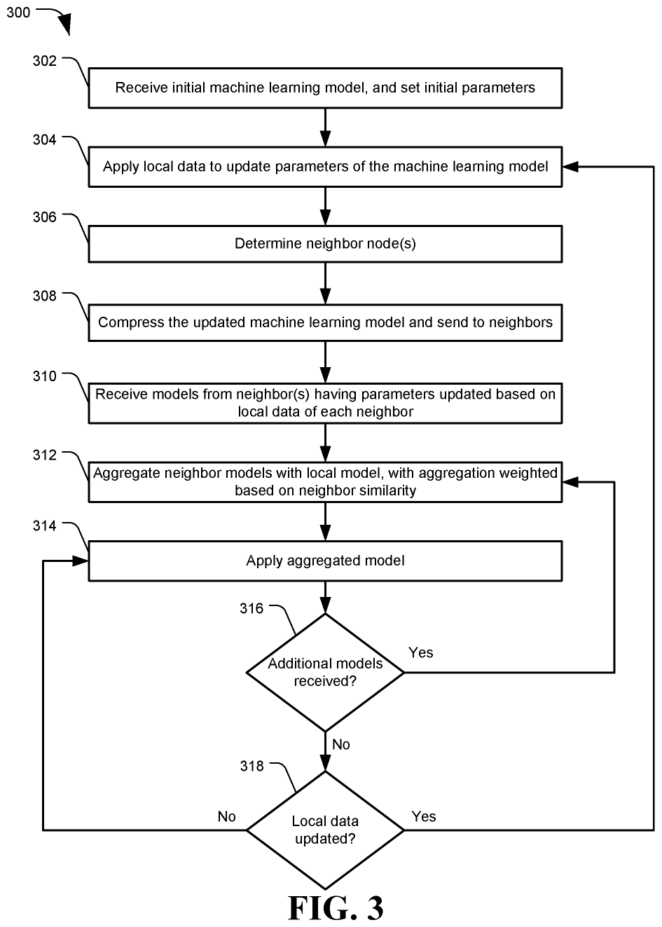

Once the network has been defined based on the nodes, edges, and similarity matrix, a decentralized model training algorithm may be performed by the various nodes, as will be described in greater detail in regard to FIG. 3.

FIG. 3 depicts a flowchart of an example method 300 of distributed decentralized machine learning model training, in accordance with certain embodiments of the present disclosure. The method 300 may be an algorithm performed by each node in the model training network in order to iteratively update and refine the model without control or oversight of a central authority configured to control dissemination or access to machine learning models in the network.

The method 300 may include receiving or obtaining an initial machine learning model, at 302. The machine learning model and decentralized model training algorithm may be obtained by a node from an original distribution source (e.g. downloaded from a third party server over a network, or purchased and installed via physical media), or the model and algorithm may be received from a neighboring network node that sent out a copy of the model updated based on that node's own data, or may be obtained via other means. The network architecture may be shared with every node that joins the network.

Each node in the network may have the same machine learning model type, or neural network architecture. However, the initial parameters of the model or the weights of the architecture may differ between nodes. A neural network machine learning model can be considered a collection of neurons at different layers within the model (e.g. an input layer, one or more hidden layer, and an output layer). The neurons are sometimes referred to as nodes in the art, but are referred to herein as neurons to distinguish from the network nodes if FIG. 1. There may be connections between each neuron at a given layer and each neuron at the next layer. The parameters of a neural network can refer to the weights of the connections between the neurons at the different layers. The parameters may be learned during a training stage, so that the training algorithm itself, and the input data (e.g. node-specific data) tunes the parameters. Therefore the initial weights or parameters of the model can be selected by each node itself. These values can be randomly selected, or set according to initialization techniques or algorithms accepted in the Deep Learning community, such as He or Xavier initialization. The weights or parameters may be stored to a memory of the node.

At 304, the method 300 may include applying local data to update parameters of the local copy of the machine learning model. At first initialization, this may include setting the initial parameters of the model. The local data sets can include customer data, sales data, health data, crime statistics, viewership data, or any other kind of data to which machine learning can be applied. Machine learning models can be algorithms or rule sets used to determine patterns found in data, for example so that predictions can be made about the results of hypothetical or future data. There are a variety of machine learning models, and therefore which parameters (e.g. weights) are updated by the local data can vary from model to model. The local data may be used to update or refine the local model, but it may not be incorporated directly into the model. Therefore the local data may be used at each node to refine the local model, but the local data may be kept secure at the node even if the model itself is later shared. Therefore sensitive data can be used to improve models shared with other nodes, without scrubbing the data of sensitive or personally identifying information.

The method 300 may include determining neighbor nodes, at 306. The definition of neighbors may be defined as k degrees of separation from that node via edges 104 of network 110, e.g., a node j may be a neighbor of node i if node j can be reached by traversing at most k edges. In another embodiment, instead of defining the neighbors to be nodes separated by k degrees, neighboring nodes can also be directly defined based on the node similarity matrix. In this case, node i and node j would be neighbors if the similarity between the nodes is greater than some threshold value t.

In a scenario where the machine learning network has not yet been established, a new network and similarity matrix may be built from scratch. Each node may have its own self-describing vector. Using MPC, a similarity matrix can first be calculated among all the nodes. Once this similarity matrix has been calculated, the model training can begin. In a scenario where a new node joins an existing network, the new node may receive the existing similarity matrix from any neighbor. Using MPC the new node may calculate its own portion of the new similarity matrix and broadcast it to all nodes. Once any preexisting nodes receive this updated matrix, model updates can be shared from and to the new node. Since each node has the same similarity matrix, they can essentially “see” the network, and figure the neighbor nodes.

Network addresses may be masked and stored as a coded connection file in the peer to peer network, so that the network details of the other peers are not stored in readable format. While connecting to the peer to peer network a node may utilize this connection file. In some embodiments, network addresses for nodes included in the machine learning network or similarity matrix may be shared or provided along with the matrix, the machine learning model and algorithm, or otherwise disseminated. This communication of machine learning models between nodes can be performed using various peer-to-peer sharing techniques, for example using a gossip protocol.

Once the neighbor nodes have been determined, the method 300 may include compressing the local machine learning model (updated based on the local data set), and sharing or sending the model to the determined neighbor nodes, at 308. Compressing the model may reduce network bandwidth required to transmit the model to neighboring nodes. The model may be broadcast to all determined neighbors simultaneously, sent to a random or selected subset of neighbors at selected intervals (e.g. sent to five randomly selected neighbors in intervals of one hour until all neighbors have received the model), or otherwise distributed. The node may send the model to all determined neighbors directly, or may only send the model to first-degree neighbors, with instructions to forward it along to their respective neighbors with a decreasing counter after every transmission, to reach neighbors at k degrees of separation from the original node.

At 310, the method 300 may include receiving one or more models from one or more corresponding neighbors. The received models may have parameters updated based on the local data of the sending neighbor, or, in some examples, based on the data from a neighbor of the sending neighbor, up to k degrees of separation. The models may include a version number, so that if a node receives a same update from multiple neighbors it can ignore duplicates (e.g. node B is a kth degree neighbor of node A via both nodes C and D, and therefore receives node A's model update twice via both nodes C and D).

At 312, the method 300 may include aggregating the one or more neighbor models with the receiving node's own local model, to further update the local model. The aggregation can be unweighted, or weighted based on the node similarity matrix. For example, a model from a node that is very similar to the receiving node may be given a high weight, thereby influencing the local model more. A model from a node that is less similar may be given a lower weight, so that the local model is less influenced by models from dissimilar nodes. If the k degrees of separation is kept to a relatively low k value, then model sharing can primarily be performed between similar neighbors, establishing a “galaxy” of similar nodes sharing models. Weighting of the received models can further create defined galaxies of similar nodes sharing similar models. This prioritizing of model sharing and weighting between similar nodes can result in specialized models that are more adapted to the particular element for which the nodes in a galaxy share common characteristics.

The method 314 may include applying the aggregated model, at 314. Applying the model may include using the model to influence operation of the node. For example, the model may be used to make predictive suggestions, such as for health diagnoses or product recommendations to a user, for generating weather or economic predictions, or for other applications. In this manner, the operation of a computer system may be improved by enabling the system to make increasingly accurate recommendations, predictions, or operations based on the aggregated model information. Further, machine learning model training is improved by allowing the free sharing and aggregation of models based on the full information from local data sets, without exposing the privacy of the information, while distributing processing workload, and while keeping the models widely available and not controlled by a central authority.

At 316, the method 300 may include determining whether additional models have been received from neighboring nodes. If yes, the method may return to 312, and the received models may be aggregated into the local model. If not, a determination may be made at 318 whether the local data of the node has been updated. If yes, the method may return to 304, with the updated local data applied to update the local model parameters. If the local data has not been updated, the method may return to 314, where the current model is applied. In some embodiments, the method 300 may include sharing the local model to neighbors, at 306 and 308, whenever the local model is updated, for example, based on aggregating models received from other neighbors.

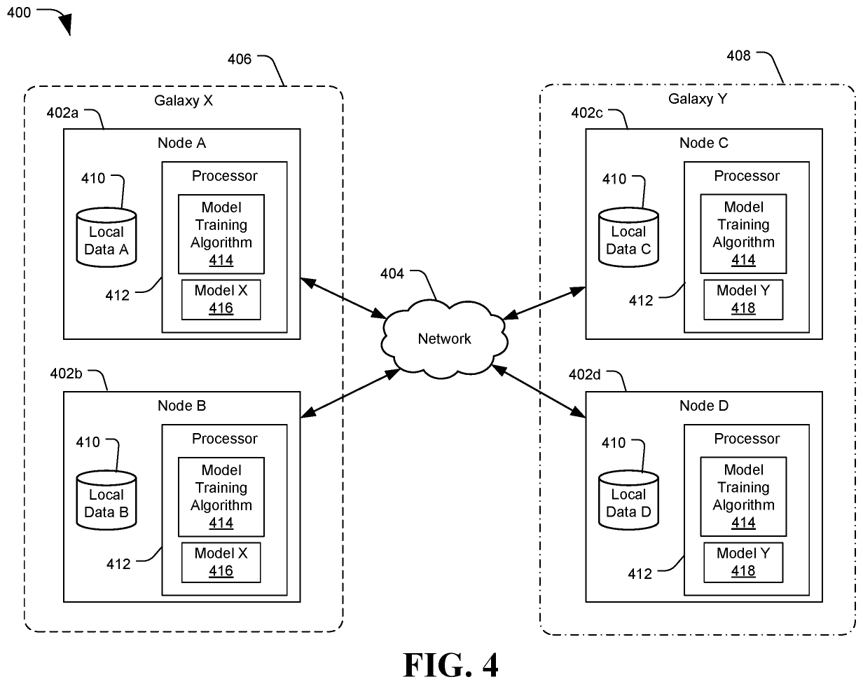

The method 300 may continue to iterate repeatedly to further refine the model at each node. Via the described method, different galaxies of nodes within a network may converge to different machine learning models. These models may be specialized enough on a single galaxy that they will perform better than a global averaged model. Further, the method may also be able to provide k-level differential privacy in a system or galaxy with enough member nodes. An example set of nodes from different galaxies is discussed in regard to FIG. 4.

FIG. 4 is a diagram of a system, generally designated 400, for distributed decentralized machine learning model training, in accordance with certain embodiments of the present disclosure. In particular, system 400 includes a plurality of nodes 402 connected to a network 404, such as the internet. Each node 402 may include one or more computing devices configured to perform the decentralized computer learning model training as described herein.

The plurality of nodes 402 may include node A 402a, node B 402b, node C 402c, and node D 402D. The nodes 402 may have attributes that makes each node more or less similar to the other nodes, such as described in regards to similarity matrix 200. Similar nodes may be logically grouped together as being within a same “galaxy” of nodes. In the depicted example, node A 402a and node B 402b may be similar to each other and logically grouped into galaxy X 406, while node C 402c and node D 402d may be similar to each other and logically grouped into galaxy Y 408. The galaxies may not represent geographical or spatial relationships, although geographical area may be one consideration used in determining the similarity of nodes 402.

Each node 402 may be connected, directly or indirectly (e.g. via an edge server of a local intranet) to the network 404, which may itself be a local area network (LAN) or a wide area network (WAN). The connection of each node 402 to the network 404 may be via wired or wireless communication mediums, or a combination thereof.

Each node 402 may include a data storage medium 410 storing a local data set specific to the node 402. The data at each node 402 may include secret, proprietary, privileged, or sensitive data not available to systems outside the node 402, in addition to non-secure or public data. Each node 402 may also include one or more processors 412, which may include general purpose circuits, application specific integrated circuits (ASIC), field programmable gate arrays (FPGAs), memory devices, other components, or a combination thereof.

Each processor 412 may also include (e.g. load software or firmware from memory and execute, or be configured to perform via hardware) a model training algorithm 414. The model training algorithm 414 may include instructions, modules, etc. for executing the distributed decentralized machine learning model training as described herein. An example model training algorithm 414 may correspond to method 300. The processor 412 may also include a local copy of a machine learning model, such as model X 416 or model Y 418, which may be applied at the node 402 for determining operations to perform or to predict outcomes based on proposed data.

Each node 402 may initially receive a same version of a general model, or nodes may receive different versions or iterations of a same model (e.g. the same model with different weights). The processor 414 of the node 402 may apply the local data 410 to update the local copy of the model via the model training algorithm 414. This updated local model may be shared to neighbor nodes 402, such as nodes within the same galaxy as the sharing node 402. For example, node A 402a may share its local copy of model X 416 with node B 402b, and node B 402b may share its local copy of model X 416 with node A 402a, as both nodes are within the same galaxy X 406. Each node may aggregate the models shared with it to update its own local model, according to model training algorithm 414. Over time, the models of each node within a galaxy may come to be the same or very similar. For example, model X 416 of both nodes A 402a and B 402b may become identical or very similar, on account of the shared and aggregated models among nodes of the galaxy X 406. Similarly, model Y 418 of nodes C 402c and D 402d may become similar, due to the distributed, decentralized machine learning system, and similarity clustering from the similarity matrix and the corresponding node galaxies. Models within a galaxy may become homogeneous, while models of different galaxies may be heterogeneous.

The machine learning network can be understood as sharing a single model architecture, which may evolve based on the various galaxies into multiple sub-models consisting of a multiple sets of model weights suited to similar nodes 402, with each sub-model providing better accuracy than a standard machine learning model trained on the total data of the entire network. Distributed networks allow multiple sub-models to be developed for the different use cases, where each sub-model is catering to a galaxy of similar nodes 402. Such a network of specialized models can perform better than a single model trained on all the data. Further, the models may be trained on the data sets of multiple nodes 402, while maintaining data security. Privacy of each user may be preserved, as the data never leaves the node 402, and only the trained model is sent to the network to be aggregated. The model may not be owned by a single central authority, but can be shared or owned by the network itself.

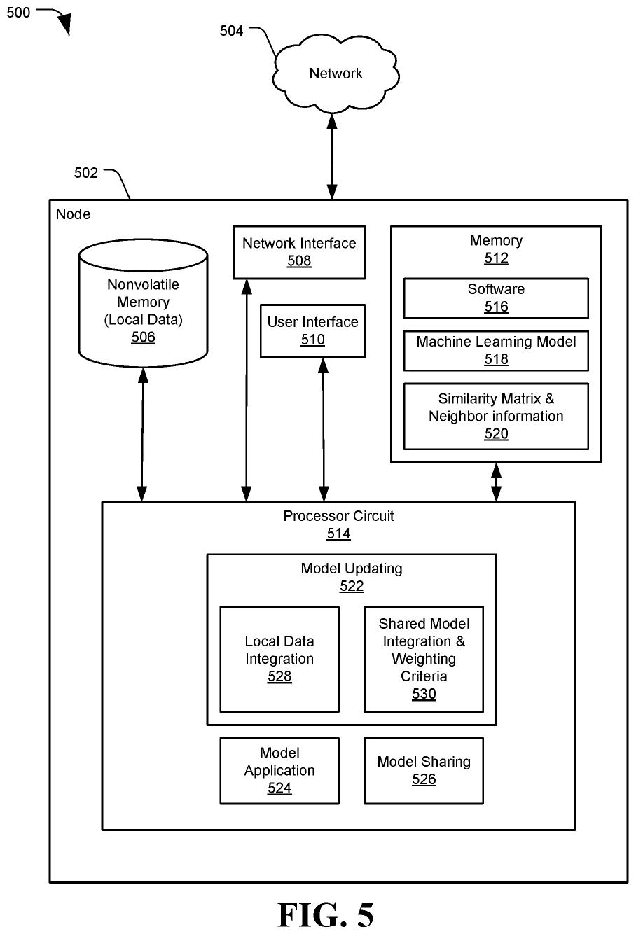

To prevent malicious users or nodes 402 from affecting the model training, users can be authenticated by zero knowledge proofs or zero knowledge protocols, or other algorithms that prevent malicious adversaries from creating a large number of nodes 402 in a network. Another example of a node of the present system is described in regard to FIG. 5.

FIG. 5 is a diagram of a system, generally designated 500, for distributed decentralized machine learning model training, in accordance with certain embodiments of the present disclosure. In particular, system 500 includes an example node 502 connected to a network 504. The network 504 may correspond to a LAN or WAN, such as the internet, which may facilitate the communication between a plurality of nodes, including node 502. The node 502 is an example of a computing device configured to perform the decentralized computer learning model training as described herein, although in some examples a node 502 may comprise a plurality of computing devices. Node 502 may correspond to node 402 of FIG. 4 and node 102 of FIG. 1. Node 502 may include nonvolatile memory 506, network interface 508, user interface 510, memory 512, and processor circuit 514.

Nonvolatile memory 506 may store local data for node 502, and sometimes may be referred to as local data 506. The nonvolatile memory 506 may include one or more hard drives, nonvolatile solid state memories like NAND Flash, tape drives, recordable removable disc memories such as compact disc (CD), digital versatile disc (DVD), or Blu-ray disc (BD), or any combination thereof. The nonvolatile memory 506 may be included within a same housing as other components of node 502, or may be separate devices. For example, node 502 may include a server rack or RAID (redundant array of independent discs) system, where there may be a plurality of nonvolatile memory devices 506 managed by single controller or processor 514. The local data 506 may include a collection or database of information that can be used to train a machine learning model. The local data 506 may include sensitive, proprietary, or otherwise secret information that should not be shared from node 502 to the network 504.

Network interface 508 may include any wired or wireless interface that enables the node 502 to connect to the network 504, such as Wi-Fi, Ethernet, fiber-optic, cable, wireless broadband, other interfaces, or any combination thereof. The network interface 508 may also include software, firmware, or hardware used to convert data into a format for transmission over the network 504, or convert messages received via the network 504 into a different format for use at node 502.

User interface 510 may include one or more hardware devices or software systems configured to allow a human user to interface with node 502. For example, user interface 510 may include a visual display such as a monitor, as well as software that organizes data to be presented in a format that is understandable and interactable by a human user. User interfaces may also include keyboards, touch screen, pointer devices, audio speakers and microphones, other systems, or any combination thereof. Via the user interface 510, a human may be able to interact with the machine learning model system as described herein. For example, a user may be able to enter additional local data 506, instruct the node 502 to perform an update iteration on the machine learning model 518, or apply the model 518 by presenting a real or hypothetical data set to the model to determine the results predicted by the model.

The memory 512 may include volatile memory, such as dynamic random access memory (DRAM). Memory 512 may provide fast data access, and may be used to store data for running software 516, the machine learning model 518, or the similarity matrix and neighbor information 520. Software 516 may generally relate to any programs or operations running at the node (e.g. on processor circuit 514), including an operating system, drivers, user applications, algorithms or instructions for updating and applying the machine learning model 518, or any other software or firmware. Memory 512 may also store a copy of the machine learning model 518 itself, which may be updated in memory 512 based on the local data 506 or models from neighboring nodes, may be applied to data to determine patterns in the data or predict outcomes based on data, or to control other operations of the node 512 based on the model 518. The memory 512 may also store a copy of a similarity matrix, neighbor information, or both 520. The similarity matrix or neighbor information 520 may be accessed to determine neighbor nodes with which to share a copy of the local machine learning model 518, to determine relative weights to apply to models received from neighbors when aggregating neighbor models with the local model 518, or for other purposes. Data stored in the memory 512 may be backed up to a nonvolatile memory 506, so that information such as the machine learning model 518 and similarity matrix and neighbor node information 520 will not be lost if power is removed from the memory 512.

Processor circuit 514 (sometimes referred to as simply “processor” or “circuit”) may be configured to control general operations and processing of the node 502, for example based on executing hardware or firmware instructions, or as a specifically designed circuit. The processor 514 may be a stand-alone circuit, or may be an integrated circuit including one or more other components of node 502, such as network interface 508 or memory 512. The processor 514 may execute instructions or modules to perform various tasks for distributed decentralized machine learning model training, as described herein. For example, processor 514 may include a model updating module 522, a model application module 524, and a model sharing module 526, and may also perform operations such as data access operations to nonvolatile memory 506 or volatile memory 512.

Model updating module 522 may include instructions for modifying local copy of the machine learning model 518, such as based on local data 506 or based on models received from neighbor nodes. The model updating module 522 may therefore include a local data integration module 528, and a shared model integration and weighting criteria model 530. The local data integration module 528 may include instructions or algorithms for how the local data 506 may be used to update or adjust the parameters of the machine learning model 518. Machine learning models may be implemented in a variety of ways, so the ways in which the local data 506 may be applied to update the model 518 are also varied, but may include elements such as defining data fields that may be used to update the model, relative weights of various kinds or combinations of data, or other factors. The shared model integration and weighting criteria module 530 similarly may include instructions on how to aggregate models received from neighbor nodes with the local model 518. For example, the weighting criteria module 530 may instruct the processor 514 to access the similarity matrix 520 from memory 512. Based on the similarity between the current node 502 and the node that sent a new model, the weighting criteria module 530 may instruct how much or little weight the received model should have when integrated with the local model 518, with models from less similar nodes being given less weight.

The model application module 524 may include instructions on how the machine learning model 518 may be applied at or by the node 502. For example, the model application module 524 may control how a model or its results should be presented to a user over the user interface 510. The application module 524 may control what inputs may be presented to the model 518 and how outputs should be interpreted, for example to predict an outcome or to determine which advertisements, health suggestions, or other content should be presented to a selected individual. The model application module 524 may also control one or more operating modes of the node 502, for example based on determining an optimal course of action from prior data sets.

Model sharing module 526 may include instructions on how the local copy of the machine learning model 518 should be shared with other nodes via network 504. For example, the sharing module 526 may instruct the processor 514 to compress a copy of the machine learning model 518 and provide it to the network interface 508 for conversion into data packets for sending over the network 504. The processor 514 may also be instructed to determine recipient or neighbor nodes based on the similarity matrix and neighbor information 520, which may define edges between nodes, similarity of other nodes to the current node 502, addressing information for other nodes, or similar information which may be applied in determining target nodes and sending the model 518. The model sharing module 526 may control how many degrees of separation are used when sharing among neighbor nodes, or similarity thresholds used to determine which nodes constitute neighbors. In some embodiments, the parameters of the modules, or the information in memory 512, may be modified or updated, for example based on user input via user interface 510. For example, the similarity matrix and neighbor information 520 may be entered or modified by a user, or similarity thresholds used by weighting criteria 520 or model sharing module 526 may be adjusted. These modules and values may also be updated, e.g. via other nodes or users via network 504 and network interface 508. Other embodiments are also possible.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method comprising:
receiving, at a first node in a network including a set of nodes, an initial machine learning model;
applying local data of the first node to update parameters of the initial machine learning model to generate an updated machine learning model;
transmitting a copy of the updated machine learning model from the first node to a first neighboring node in the network;
receiving, at the first node, a modified machine learning model from the first neighboring node, the modified machine learning model having parameters set based on local data of the first neighboring node;
modifying, at the first node, the updated machine learning model based on the modified machine learning model; and
applying the updated machine learning model to perform operations at the first node.

2. The method of claim 1 further comprising:
determining a plurality of neighboring nodes, including the first neighboring node, from the set of nodes in the network; and
transmitting the copy of the updated machine learning model from the first node to the plurality of neighboring nodes.

3. The method of claim 2 further comprising:
determining the plurality of neighboring nodes includes determining nodes within a selected number of degrees of separation from the first node; and
a degree of separation includes two nodes separated by a single edge of the network.

4. The method of claim 3 further comprising:
transmitting the copy of the updated machine learning model from the first node to the plurality of neighboring nodes includes:
transmitting the copy of the updated machine learning model and the selected number of degrees of separation from the first node to first-degree neighbors of the first node; and
instructing the first-degree neighbors to forward the updated machine learning model to respective neighbors of the first-degree neighbors while decreasing a counter corresponding to the selected number of degrees of separation.

5. The method of claim 1 further comprising:
accessing, at the first node, a similarity matrix data structure having numeric representations of similarity values between different nodes in the network; and
determining the first neighboring node as a node sharing a similarity value over a selected threshold with the first node.

6. The method of claim 5 further comprising:
modifying, at the first node, the updated machine learning model based on the modified machine learning model includes:
applying a weighting factor to the modified machine learning model based on the similarity value of the first neighboring node to the first node; and
aggregating the updated machine learning model and the modified machine learning model based on the weighting factor.

7. The method of claim 1 further comprising:
applying the local data of the first node to update parameters of the initial machine learning model includes adjusting the parameters of the initial machine learning model without incorporating the local data directly into the initial machine learning model; and
not transmitting the local data to another node in the network.

8. The method of claim 1 further comprising:
providing the updated machine learning model to other nodes in a peer-to-peer fashion, without influence by a central processing authority configured to control dissemination of machine learning models in the network.

9. A memory device storing instructions that, when executed, cause a processor to perform a method comprising:
receiving, at a first node in a network including a set of nodes, the first node including the processor, an initial machine learning model;
applying local data of the first node to update parameters of the initial machine learning model to generate an updated machine learning model;
transmitting a copy of the updated machine learning model from the first node to a first neighboring node in the network;
receiving, at the first node, a modified machine learning model from the first neighboring node, the modified machine learning model having parameters set based on local data of the first neighboring node;
modifying, at the first node, the updated machine learning model based on the modified machine learning model; and
applying the updated machine learning model to perform operations at the first node.

10. The memory device of claim 9 storing instructions that, when executed, cause the processor to perform the method further comprising:
determining a plurality of neighboring nodes, including the first neighboring node, from the set of nodes in the network; and
transmitting the copy of the updated machine learning model from the first node to the plurality of neighboring nodes.

11. The memory device of claim 10 storing instructions that, when executed, cause the processor to perform the method further comprising:
determining the plurality of neighboring nodes includes determining all nodes within a selected number of degrees of separation from the first node; and
a degree of separation includes two nodes separated by a single edge of the network.

12. The memory device of claim 11 storing instructions that, when executed, cause the processor to perform the method further comprising:
transmitting the copy of the updated machine learning model from the first node to the plurality of neighboring nodes includes:
transmitting the copy of the updated machine learning model and the selected number of degrees of separation from the first node to all first-degree neighbors of the first node; and
instructing the first-degree neighbors to forward the updated machine learning model to respective neighbors of the first-degree neighbors while decreasing a counter corresponding to the selected number of degrees of separation.

13. The memory device of claim 10 storing instructions that, when executed, cause the processor to perform the method further comprising:
accessing, at the first node, a similarity matrix data structure having numeric representations of similarity values between different nodes in the network; and
determining the plurality of neighboring nodes based on nodes sharing a similarity value over a selected threshold with the first node.

14. The memory device of claim 13 storing instructions that, when executed, cause the processor to perform the method further comprising:
modifying, at the first node, the updated machine learning model based on the modified machine learning model includes:
applying a weighting factor to the modified machine learning model based on the similarity value of the first neighboring node to the first node; and
aggregating the updated machine learning model and the modified machine learning model based on the weighting factor.

15. The memory device of claim 14 storing instructions that, when executed, cause the processor to perform the method further comprising:
applying the local data of the first node to update parameters of the initial machine learning model includes adjusting the parameters of the initial machine learning model without incorporating the local data directly into the initial machine learning model;
not transmitting the local data to another node in the network; and
providing the updated machine learning model to other nodes in a peer-to-peer fashion, without oversight by a central processing authority configured to control dissemination of machine learning models in the network.

16. An apparatus comprising:
a first node in a network, the first node including a computing system having:
a network interface configured to connect the first node to the network;
a nonvolatile memory configured to store local data;
a circuit configured to execute a distributed machine learning model training process, including:
receive an initial machine learning model;
apply the local data to update parameters of the initial machine learning model to generate an updated machine learning model;
transmit a copy of the updated machine learning model from the first node to a plurality of neighboring nodes in the network via the network interface;
receive, via the network interface, a modified machine learning model from a first neighboring node, the modified machine learning model having parameters set based on local data of the first neighboring node;
modify the updated machine learning model based on the modified machine learning model; and
apply the updated machine learning model to control operations at the first node.

17. The apparatus of claim 16, including the circuit further configured to:
determine the plurality of neighboring nodes based on determining nodes within a selected number of degrees of separation from the first node, a degree of separation including two nodes separated by a single edge of the network.

18. The apparatus of claim 17, further comprising:
transmitting the copy of the updated machine learning model from the first node to the plurality of neighboring nodes includes the circuit configured to:
transmit the copy of the updated machine learning model and the selected number of degrees of separation from the first node to first-degree neighboring nodes of the first node; and
instruct the first-degree neighboring nodes to forward the updated machine learning model to respective neighbors of the first-degree neighboring nodes while decreasing a counter corresponding to the selected number of degrees of separation.

19. The apparatus of claim 16, including the circuit further configured to:
access a similarity matrix data structure having numeric representations of similarity values between different nodes in the network; and
determine the plurality of neighboring nodes to be nodes sharing a similarity value over a selected threshold with the first node.

20. The apparatus of claim 19, further comprising:
modifying the updated machine learning model based on the modified machine learning model includes the circuit configured to:
apply a weighting factor to the modified machine learning model based on the similarity value of the first neighboring node to the first node; and
aggregate the updated machine learning model and the modified machine learning model based on the weighting factor.
